(19) United States
(12) Patent Application Publication
(10) Pub. No.: US 2006/0070707 A1
(43) Pub. Date: Apr. 6, 2006

(54) Longitudinal frame member and spline

(76) Inventor: Laurence P. Armstrong, Weyerhaeuser, WI (US)

Correspondence Address: CARLSON, GASKEY & OLDS, P.C., 400 WEST MAPLE ROAD, SUITE 350, BIRMINGHAM, MI, 48009, US

(21) Appl. No.: 11/233,640

(22) Filed: Sep. 23, 2005

Related U.S. Application Data
(60) Provisional application No. 60/615,794, filed on Oct. 4, 2004.

(51) Int. Cl. E06B 9/24

(52) U.S. Cl. 160/371

(57) ABSTRACT

A frame includes longitudinal members secured to one another. The longitudinal members support a spline that is normally open in a first position to provide a cavity. A fabric, such a mesh screen, is arranged over the frame so that the perimeter of the screen is received within the cavities of the longitudinal members. A movable platen is actuated to engage the spline. The splines are forced into the cavities to a second position in which the perimeter of the screen is pinched between a corner of the splines and the longitudinal members. A nose of the splines, which includes the corner, is retained in a channel of the longitudinal members.

This application claims priority to provisional application No. 60/615,794 filed on Oct. 4, 2004.

### BACKGROUND OF THE INVENTION

This invention relates to a longitudinal frame member and spline for use in attaching fabric to a frame.

Frames used for windows and doors and for office furniture such a cubical dividers have fabric attached to a frame in some fashion. Other applications include ceiling panels. In the example of window frames and doors using screens, longitudinal frame members of the frame are used that have channels. The screen is positioned over the frame and a rubber spline having a generally circular cross section is inserted into the channels thereby retaining the screen between the spline and longitudinal frame members.

Installation of fabric using the spline arrangement described above or other manners of screen attachment are typically labor intensive and costly. In the example of the splines described above, a special tool having rollers must be run along the length of longitudinal member.

Window and door screens must pass an industry “push out” test. One industry standard requires that the screen be held through the longitudinal frame members for at least forty pounds of applied force. The standard can sometimes be difficult to meet.

What is needed is an improved frame that requires less labor and cost to manufacture while meeting or exceeding the present industry standard for “push out.”

### BRIEF DESCRIPTION OF THE DRAWINGS

Other advantages of the present invention can be understood by reference to the following detailed description when considered in connection with the accompanying drawings wherein:

FIG. 1A is an exploded view of a frame including longitudinal frame members with square ends.

FIG. 1B is a perspective view of the frame of FIG. 1A shown assembled.

FIG. 2A is an exploded view of a frame including longitudinal frame members with mitered ends.

FIG. 2B is a perspective view of the frame of FIG. 2A shown assembled.

FIG. 3 is a top elevational view of an inventive manufacturing process for the inventive longitudinal frame member.

FIG. 4 is a cross-sectional view of the frame of the longitudinal frame member having a screen installed.

FIG. 5 is a perspective view of barbs used to improve retention of the screen.

FIG. 6 is a cross-sectional view of another example of the inventive longitudinal frame member.

FIG. 7 is a cross-sectional view of a longitudinal frame member similar to FIG. 6 with a ridge.

FIG. 8 is a cross-sectional view of a longitudinal frame member similar to FIG. 4 with a ridge.

FIG. 9 is a cross-sectional view of a longitudinal frame member similar to FIG. 8 with a spline overmolded to a tubular portion of the frame member.

FIG. 10 is a cross-sectional view of the inventive longitudinal frame member wrapped in a decorative fabric.

### SUMMARY OF THE INVENTION

The inventive frame includes longitudinal members secured to one another, for example by using corner locks, to form a frame. The longitudinal members support a spline that is normally open in a first position to provide a cavity. A fabric, such a mesh screen, is arranged over the frame so that the perimeter of the screen is received within the cavities of the longitudinal members.

In one example, the frame is retained on a fixed platen by stops. A movable platen is actuated to engage the spline. The splines are forced into the cavities to a second position in which the perimeter of the screen is pinched between a corner of the splines and the longitudinal members. A nose of the splines, which includes the corner, is retained in a channel of the longitudinal members.

The spline is generally S-shaped. The spline may be integral with the longitudinal member or separately secured to the longitudinal member, for example, by snapping the spline into a recess in the longitudinal member.

Accordingly, the present invention provides an improved frame that requires less labor and cost to manufacture while meeting or exceeding the present industry standard for “push out.”

### DETAILED DESCRIPTION OF THE PREFERRED EMBODIMENT

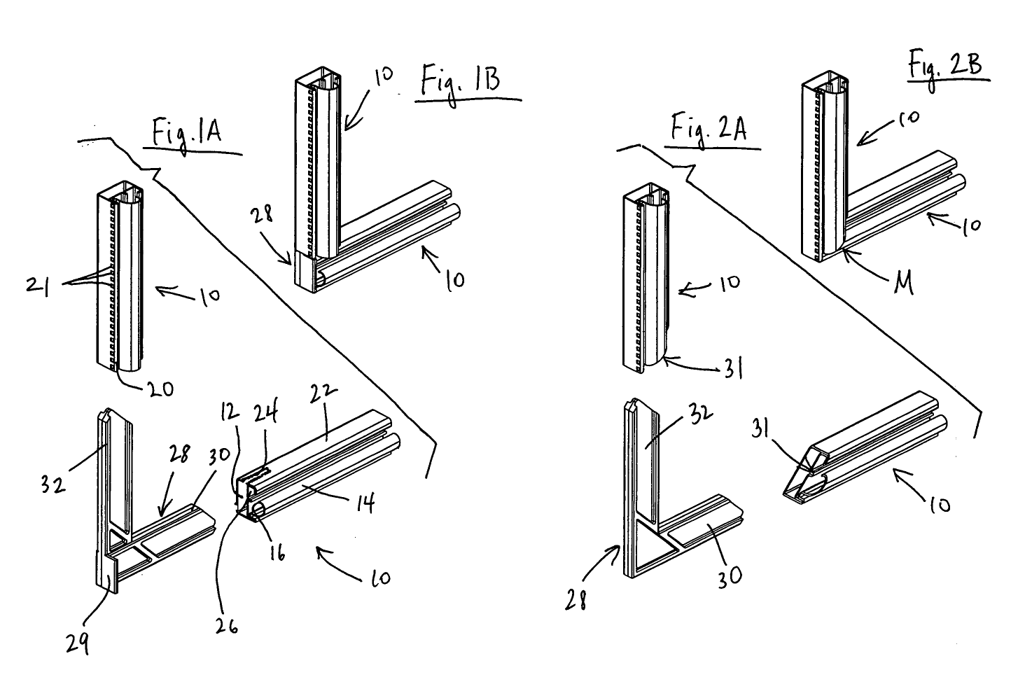

An inventive longitudinal frame member 10 is shown in the Figures. Referring to FIGS. 1A-2B, a rigid frame is constructed from the longitudinal frame member 10 that includes a tubular portion 12 and a spline 14. The tubular portion 12 provides a channel 26 that receives a portion of the inventive spline 14 to securely retain the screen to the member 10, which will be discussed in more detail below.

The example member 10 shown in FIGS. 1A-4 is roll formed out of a sheet of metal so that the spline 14 is formed integrally with the tubular portion 12. The member 10 includes a first edge 16 provided on the spline 14 and a second edge 18 provided on the tubular portion 12, best seen in FIG. 4. The integral tubular and spline portions 12 and 14 are secured to provide a desired cross-sectional shape by forming a flange 20, which is shown in FIGS. 1A and 4. The flange 20 may include a series of indentations 21 formed by a roller to further secure the metal in the desired shape, best shown in FIG. 1A. In one example, the member 10 is constructed from a suitable metal that is either roll formed and/or extruded. A plastic or other material may also be used.

Opposite the flange is a wall 22 having a slot 24 for receiving a corner lock 28. The corner lock 28 includes first and second legs 30 and 32. The first leg 30 is received in the tubular portion 12, and the leg 32 extends from the slot 24. The details of the use and assembly of the corner lock 28 are disclosed in U.S. patent application Ser. No. 10/825,525, filed on Apr. 15, 2004.

The arrangement shown in FIGS. 1A and 1B depicts longitudinal frame members 10 that have square ends. In such an arrangement, it may be desirable to provide an end cap 29 on the corner lock 28. Referring to FIGS. 2A and 2B, the longitudinal frame members 10 include mitered ends 31 that may provide for a more aesthetic mitered joint M and also eliminate the need for slot 24.

Referring to FIG. 3, a machine 34 is disclosed for securing a screen 44 to be the inventive longitudinal frame members 10. The members 10 are assembled using the corner lock 28, or any other suitable method of attachment, to provide a frame 42. The frame 42 is arranged on a fixed platen 36 having fixed stops 38. Movable stops 40 are actuated to secure the frame 42 against the fixed stops 38. The arrangement of stops 38 and 40 enables any size frame 42 to be accommodated on the machine 34.

Referring to FIG. 4, the screen 44 is positioned on top of the frame 42 with the spline 14 in a first position P1. A cavity 55 is provided between the spline 14 and the tubular member 12 in the first position P1 for receiving the screen 44. The spline portion includes a nose 46 having the first edge 16. The nose 46 extends to an arch 48 having a spring portion 49 opposite the nose 46. In the example shown in FIG. 4, the spring portion 49 is integral with the tubular portion 12. In the example embodiment, the nose 46 has a smaller radius than the gradual radius of the arch 48. The spring portion 49 has a smaller radius than the nose 46. The spring portion 49 biases the spline 14 upward and away from the tubular portion 12.

The machine 34 includes a movable platen 50 having a flat profile 52. By utilizing a flat profile 52, the tooling costs are drastically reduced since a platen of particular profile requiring machining is not required, and alignment issues between the movable platen 50 and frame 42 are eliminated.

The movable platen 50 is moved downward into engagement with the spline 14 moving the spline 14 from the first position P1 to a second position P2, which forces the perimeter of the screen 44 into the channel 26. The arch 48 extends above a flange 53 that, in part, provides the channel 26 along with a surface 58 of the tubular portion 12. The movable platen 50 continues to move downward moving the spline 14 from the second position P2 to the third position P3. In the position P3, the nose 46 is forced further into the channel 26 securely retaining the perimeter of the screen 44. The flexible spline 14 deflects without yielding. The nose 46 has a sharp corner 56 on the first edge 16 that digs into the screen 44 to retain the perimeter of the screen between the corner 56 and the surface 58. In the third position P3, the arch 48 has a larger radius than it did in first position P1, and the nose 46 has smaller radius than it did in the first position P1.

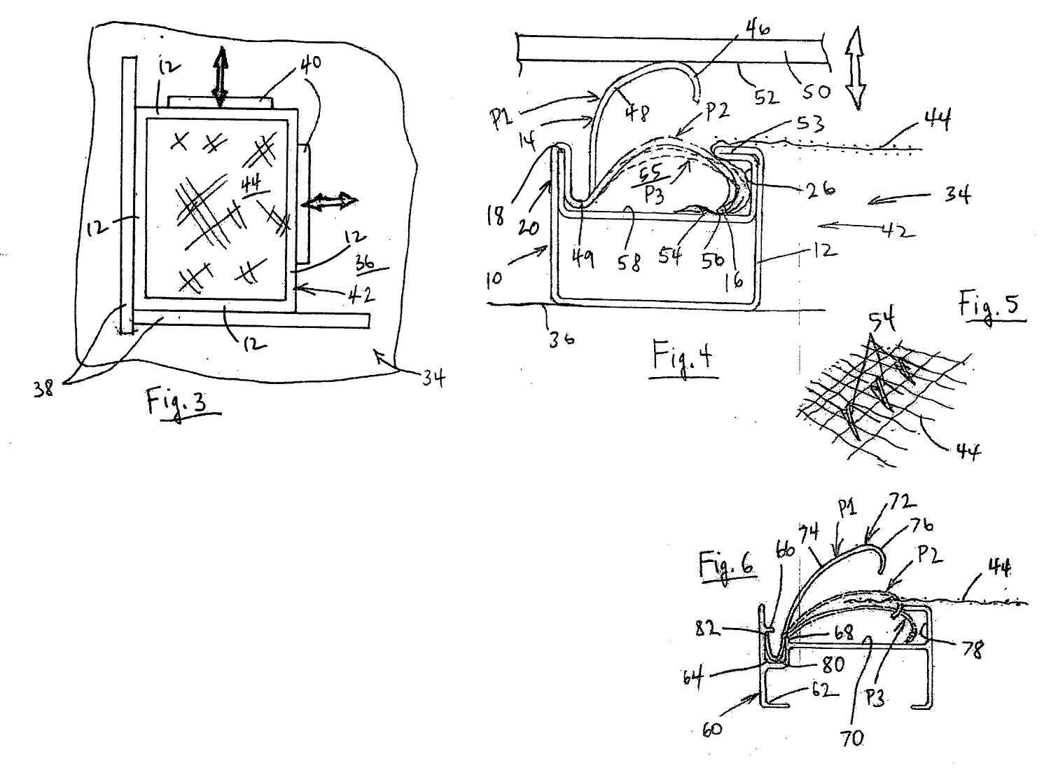

To further improve retention of the screen 44, barbs 54 may extend upward from the surface 58 and away from the channel 26, as is show in FIG. 5.

FIG. 6 depicts another example longitudinal frame member 60, which is extruded. The longitudinal frame member 60 includes a tubular portion 62 having a separate spline portion 72. The tubular portion 62 provides a recess 64 having a protrusion 66 and fulcrum 68. A spring portion 80 of the spline portion 72 is inserted into the recess 64, and an edge 82 is retained by the protrusion 66. The spring portion 80 acts against the fulcrum 68 when moving between the first, second and third positions P1, P2 and P3. Similar to the embodiment described in FIG. 4, the spline portion 72 includes an arch 74 and nose 76. The nose 76 is forced into the channel 78 by the movable platen 50. The screen 44 is retained between the nose 76 and surface 70.

The screen 44 begins to tear, which occurs at around 125 pounds of applied force, without the screen pulling out of the channel 26.

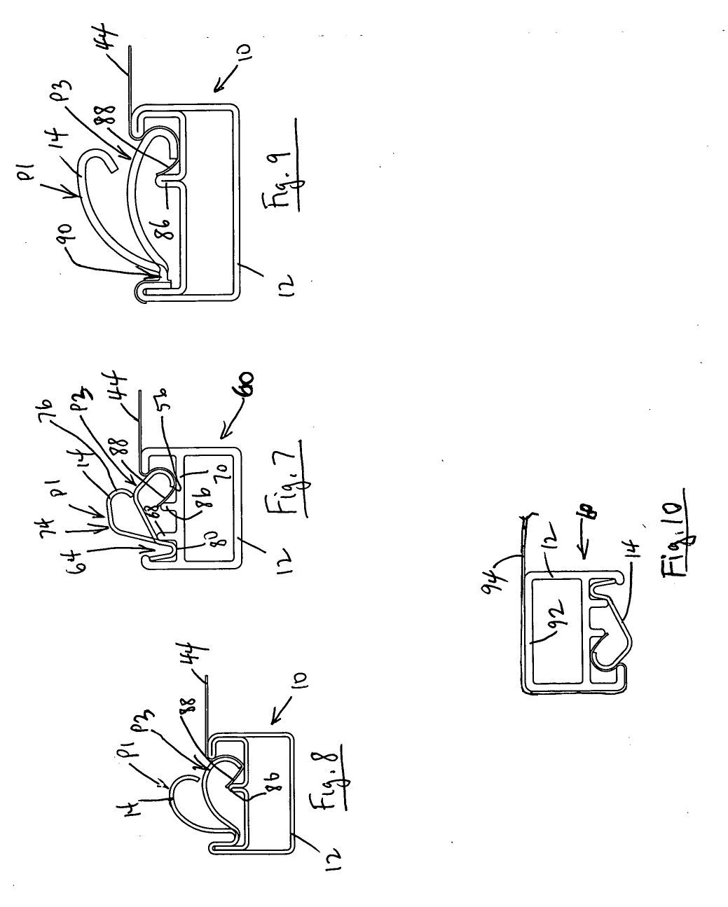

Referring to FIG. 7, the spring portion 80 is retained in the recess 64. The arch 74 may or may not include an apex, depending upon the geometry of the spline 14 and tubular member 12. The fulcrum 68 extends from the surface 70. A ridge 86 also extends from the surface 70 to lift an edge portion 88 of the screen 44 away from the surface to better ensure that the corner 56 engages and holds the screen 44. The ridge 86 is also shown for roll-formed longitudinal frame members 10 in FIG. 8.

In another example, the spline 14 can be adhered to the tubular member 12 by any suitable process, such as by laminating or overmolding, as shown in FIG. 9.

The inventive longitudinal frame member 10 permits easy replacement of the screen. The spline 14 may be “zippered” open and the damaged screen removed and replaced. With the new screen positioned as desired, the spline 14 can be forced back into the channel 26 using a block of wood and hammer.

FIG. 10 depicts the inventive longitudinal frame member 10 for furniture or other applications in which it is desirable to conceal the tubular member 12. A decorative fabric 94 is wrapped around a side 92 other than the side that supports the spline 14.

The invention has been described in an illustrative manner, and it is to be understood that the terminology that has been used is intended to be in the nature of words of description rather than of limitation. Obviously, many modifications and variations of the present invention are possible in light of the above teachings. It is, therefore, to be understood that within the scope of the appended claims the invention may be practiced otherwise than as specifically described.

What is claimed is:

1. A frame for supporting a fabric comprising:
a longitudinal member having a channel; and
a spline supported by the longitudinal member opposite of the channel, the spline including a spring portion biasing the spline to a first position, the spline movable to a second position in which a nose of the spline opposite the spring portion is received in the channel.

2. The frame according to claim 1, wherein the longitudinal member and spline are constructed from an integral metal member, the longitudinal member providing a tubular portion with one edge of the integral metal member providing the tubular portion, and another edge of the integral metal member providing a corner of the nose.

3. The frame according to claim 2, wherein the spring portion provides a fulcrum about which the nose pivots between the first and second positions.

4. The frame according to claim 1, wherein a recess is provided by the longitudinal member opposite the channel, the spring portion received in the channel.

5. The frame according to claim 4, wherein the recess provides a fulcrum about which the nose pivots between the first and second positions.

6. The frame according to claim 1, wherein a surface extends from the channel, the nose including a corner with the corner engaging the surface in the second position.

7. The frame according to claim 6, wherein the surface includes a barb, and fabric pinched between the corner and the surface, and the barb snagging the fabric.

8. The frame according to claim 6, wherein the surface includes a ridge spaced from the channel and extending from the surface toward the spline, the ridge lifting an edge portion of fabric with the fabric pinched between the corner and the surface.

9. The frame according to claim 1, wherein the longitudinal member is constructed from a first material and the spline is constructed from a second material different than the first material, the second material adhered to the first material.

10. A spline for securing a fabric to a frame comprising:
a spring portion extending in a first direction to an arch, and a nose extending from the arch in a second direction that is generally opposite the first direction and toward the spring portion.

11. The spline according to claim 10, wherein the arch and nose provide a generally C-shaped unitary member.

12. The spline according to claim 11, wherein the spring portion, arch and nose provide a generally S-shaped unitary member.

13. The spline according to claim 12, wherein the spring portion is generally U-shaped.

14. A method of securing fabric to a frame comprising the steps of:
a) supporting a longitudinal frame member with a spline supported by the longitudinal frame member;
b) arranging a fabric in a cavity of the longitudinal frame member; and
c) moving the spline toward the longitudinal frame member to capture the fabric within the cavity.

15. The method according to claim 14, wherein step a) includes retaining the longitudinal frame member with a stop, and step c) includes engaging the spline with a platen.

16. The method according to claim 14, wherein the spline includes an arch having a first radius in a first position corresponding to step a), and the arch having a second radius greater than the first radius in a second position corresponding to step c).

17. The method according to claim 14, wherein step c) includes pinching the fabric between a corner of the spline and the longitudinal member.

18. The method according to claim 17, wherein step b) includes lifting an edge portion of the fabric toward the spline with a feature of the longitudinal member.

19. The method according to claim 14, wherein step a) includes snapping the spline into a recess in the longitudinal member.

20. The method according to claim 14, wherein step b) includes arranging the fabric to cover a side of the longitudinal member other than the side having the spline.
